(19) United States
(12) Patent Application Publication
(10) Pub. No.: US 2005/0234920 A1
(43) Pub. Date: Oct. 20, 2005

(54) System, computer-usable medium and method for monitoring network activity

(76) Inventor: Lee Rhodes, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/021,942

(22) Filed: Dec. 22, 2004

Related U.S. Application Data
(60) Provisional application No. 60/559,808, filed on Apr. 5, 2004.

(51) Int. Cl. G06F 7/00

(52) U.S. Cl. 707/10

(57) ABSTRACT

A system couples to a network and monitors activity thereon. The system comprises one or more capture modules. Each capture module comprises a collection, statistical, and analysis modules. The collection module collects flow records from an observation point within the network, wherein the flow records are collected per a first set of configuration parameters. The statistical module generates a statistical result from the flow records as each flow record is collected, wherein the statistical result is generated per a second set of configuration parameters. The analysis module analyzes the statistical result to monitor network activity associated with the observation point, wherein the statistical result is analyzed per a third set of configuration parameters. The first, second and third sets of configuration parameters can generally be modified at any time, after abnormal activity is detected, to alter a magnification level by which a subset of the network activity is monitored.

### BACKGROUND

Computer security is a significant issue, especially for computer systems connected to a network, such as a local area network (LAN) or a wide area network (WAN). The Internet is one example of a WAN that may pose a significant security risk. Thus, computers connected to the Internet have a need for reliable security measures to detect or prevent security breaches.

By way of example of a security breach, network attack tools (such as denial-of-service “DoS” attack utilities) are becoming increasingly sophisticated and, due to evolving technologies, simple to execute. For this reason, relatively unsophisticated attackers can arrange, or be involved in, computer system compromises directed at one or more targeted facilities. A network system attack (also referred to herein as an intrusion) is an unauthorized or malicious use of a computer or computer network and may involve hundreds to thousands of unprotected network nodes in a coordinated attack on one or more selected targets.

### BRIEF SUMMARY

In accordance with at least one embodiment, a system couples to a network and monitors activity on the network. The system comprises one or more capture modules. Each capture module comprises a collection module, a statistical module, and an analysis module. The collection module collects a stream of flow records from an observation point within the network, wherein the stream of flow records are collected in accordance with a first set of configuration parameters. The statistical module generates a statistical result from the stream of flow records as each flow record is collected, wherein the statistical result is generated in accordance with a second set of configuration parameters. The analysis module analyzes the statistical result to monitor network activity associated with the observation point, wherein the statistical result is analyzed in accordance with a third set of configuration parameters. The first, second and third sets of configuration parameters can generally be modified at any time, after abnormal activity is detected by the analysis module, to alter a magnification level by which a subset of the network activity is subsequently monitored. Related methods and computer-usable media are also disclosed.

### BRIEF DESCRIPTION OF THE DRAWINGS

For a detailed description of the embodiments of the invention, reference will now be made to the accompanying drawings in which:

FIG. 1A is a block diagram illustrating an exemplary network usage analysis system including one or more capture modules in accordance with the present invention;

FIG. 1B is a block diagram illustrating one embodiment of a summary packet or “flow record” containing exemplary network usage data about one or more traffic packets;

FIG. 1C is a block diagram illustrating an embodiment in which a single capture module is included within the network usage analysis system of FIG. 1A;

FIG. 1D is a block diagram illustrating an embodiment in which multiple capture modules are included within the network usage analysis system of FIG. 1A;

FIG. 2 is a block diagram illustrating one embodiment of a network;

FIG. 3 is a flow-chart diagram illustrating one embodiment of a method for detecting abnormal activity within a network;

FIG. 4A is a graph displaying exemplary statistical results that may be obtained by employing the method of FIG. 3;

FIG. 4B is a graph displaying additional exemplary statistical results that may be obtained by employing the method of FIG. 3;

FIGS. 4C-4D are graphs displaying exemplary analysis results that may be obtained by employing the method of FIG. 3;

FIG. 5 is a graph displaying exemplary statistical results that may be used for detecting flood attacks;

FIG. 6 is a graph displaying exemplary statistical results that may be used for detecting address spoofing; and

FIGS. 7A-7E are graphs displaying exemplary statistical results that may be used for detecting subscriber bandwidth abuse.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion,-and thus should be interpreted to mean “including, but not limited to . . . .” Also, the term “couple” or “couples” is intended to mean either an indirect or direct connection. Thus, if a first device is coupled to a second device, that connection may be through a direct connection, or through an indirect connection via other devices and connections.

Although the term “network” is specifically used throughout this application, the term network is defined to include the Internet and other network systems, including public and private networks that may or may not use the TCP/IP protocol suite for data transport. Examples include the Internet, Intranets, extranets, telephony networks, and other wire-line and wireless networks. Although the term “Internet” is specifically used throughout this application, the term Internet is merely one example of a “network.”

Although the terms “network usage data” and “flow record” are used throughout this application for referencing the metadata included within each summary record of network traffic packets, the term “network usage data” may be considered a more general term for referencing one or more “flow records.”

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Network usage analysis systems provide important information about usage on the network. In the context of an Internet Service Provider, network usage analysis systems are used to provide vital business information, such as information for subscriber billing, product development, and pricing schemas tailored for various classes of subscribers. Network usage analysis systems can also be used to identify (or predict) abnormal network activity, such as activity caused by network congestion and network security breaches. In one example, network utilization and performance (as a function of subscriber usage behavior) may be monitored to track the “user experience,” forecast future network capacity, or identify network usage behavior indicative of network abuse, attack, fraud and theft.

Network usage data reporting systems are network devices, which not only participate in the transfer of network traffic between parties, but also have certain accounting capabilities for collecting, correlating, and aggregating network usage data (i.e., information about the network traffic) as it occurs (i.e., in “real-time”). In general, network usage data reporting systems may include substantially any network device capable of monitoring network traffic and collecting network usage data about that traffic. Exemplary network devices include routers, switches and gateways, and in some cases, may include application servers, systems, and network probes.

Network traffic is made up of data that is transferred between two points in a network in a stream of “packets.” These packets (or “traffic packets”) may include a subset of the data to be transferred between parties. When passed through a network usage data reporting system, network usage data is collected from the traffic packets, and then correlated and/or aggregated to create a summary record (or “flow record”). In other words, a flow record provides summary information about multiple traffic packets. The information within each flow record is usually determined by the particular network device responsible for generating the record, but often includes a source address and/or port #, a destination address and/or port #, a start time, an end time, and one or more traffic packet statistics (e.g., a packet or byte count), among other types of information. The flow records may be temporarily stored within the network usage data reporting system.

In particular, network usage data from traffic packets sharing a common flow record field entry may be grouped as each packet is received by a network usage data reporting system. Any one of the flow record fields, or a combination thereof, may be used for grouping the data from the incoming traffic packets. For example, traffic packets may be grouped for sharing a common source address/port # and/or a common destination address/port #. The network usage data within each group of traffic packets may then be summarized into a small record, which is temporarily stored within the reporting system as the “flow record.” In one embodiment, a flow record may include an entry for each unique source address received by the reporting system, where each entry specifies the number of bytes in each traffic packet sent from the unique source address.

The flow records may be transferred (or retrieved) from the temporary data storage location at regular and frequent intervals as a “stream” of flow records (or a “network usage data stream”). Depending on the amount of storage space available, the transfer intervals may be substantially instantaneous or may range from mere seconds to several minutes. In one embodiment, the flow records are exported to a specified destination (e.g., a network usage analysis system) at a predetermined sampling rate (e.g., on the order of 10⁴ flow records per second) or when the number of flow records within the temporary storage location reaches a predetermined maximum—which ever occurs first.

It is often impractical to store all of the raw data from a network usage data stream within a hard-disk database system, due to the high volume and rate at which the data is presented to the database system. In fact, some database systems are incapable of handling the high momentum data streams output from a data reporting system (e.g., single disk database systems begin to fail at data stream rates of about 1,000 transactions/second). Though some high-end database systems may be capable of handling several hundred thousand transactions/second, they are usually extremely expensive to purchase and require an expensive support infrastructure to maintain. Furthermore, even if one were able to store the raw data within these large database systems (usually referred to as “data warehouses”), the sheer volume of stored data may preclude any possibility for timely analysis.

A network intrusion detection system (IDS) is provided herein as one example of a network usage analysis system that does not store the network usage data stream within a database system. For this reason, the network IDS provided herein may be used for real-time analysis of high momentum data streams.

As used herein, a “high momentum data stream” refers to any volatile data that is presented at a significantly high rate (usually measured in units of “transactions per second”). A “significantly high rate” may refer to a range extending, for example, between about one thousand transactions/second and several hundred thousand transactions/second, or greater. Even faster rates may be possible in the future. Though the current discussion focuses on Internet usage data, other examples of volatile data may include: satellite or transponder data (such as weather data, satellite imaging data, data from space probes, etc.), seismic data (from earthquakes, oil exploration, etc.), and particle traces from high-energy physics experiments, among others.

Because the disclosed network intrusion detection system does not store the data, the system may analyze high momentum data streams without sampling, compressing, and/or aggregating the data stream, all of which would otherwise result in data loss. In other words, the network IDS described herein may be capable of analyzing “volatile data,” i.e., data that may be lost if it is not analyzed immediately, or before any attempts are made to sample, compress, aggregate and/or store the raw network usage data stream generated by the reporting system.

By avoiding the data loss that inevitably results from sampling, compressing and/or aggregating the network usage data stream, the network intrusion detection system may be capable of detecting certain types of network security issues that may otherwise be undetectable. For purposes of this discussion, network security issues can be divided into three categories comprising: network attacks, abuse, and fraud/theft.

In one example, a malicious user may use a network attack tool to perpetrate an attack on a single destination address (or port) by sending a large amount of traffic to the targeted address from a single source, or in some cases, from multiple sources. Such an attack is often referred to as a “flood attack” or a “denial of service” (DoS) attack. Attacks of this type tend to create congestion, deny service, infect systems and/or destroy resources (such as data and files) on the system targeted by the attack. For this reason, flood attacks are generally easy to detect once they have occurred (e.g., a server brought down by the attack may cause thousands of customers to complain). Although understanding where the flood attack originated may be useful, it is often too late by the time the attack is detected, since many transmitters of the flood traffic are unwitting users that have Trojans infecting their systems. Thus, it is often more beneficial to monitor network activity for “attack precursors,” or events that provide early indication of a possible upcoming attack.

Scanning is one example of an attack precursor, and generally includes address scans and port scans. Address scans are typically hostile traffic used to probe multiple destination addresses in order to discover an open or accessible machine. On the other hand, port scans usually probe multiple ports on a single machine in order to discover an open or accessible port or application on that machine. Scan traffic cannot usually be detected using sampled or overly aggregated data, due to the small fraction of normal traffic volume typically consumed. By avoiding data loss, the network intrusion detection system described herein is able to detect scan traffic, and thus, utilize an effective tool for early indication of upcoming attacks.

Most Internet Service Providers have end-user-agreements that forbid the use of subscriber-run servers, due to the excessive bandwidth consumed by the traffic sent to and from those servers. In addition, each user that subscribes to a Service Provider's network may be allocated a certain amount of network bandwidth. However, the usage difference between an abusive user (e.g., a subscriber running a forbidden server) and a light user makes it difficult to not only forecast future need, but also to implement fixed-price, all-you-can-use pricing plans without exceeding current network capacity.

In addition to attacks, the network IDS described may successfully detect subscriber bandwidth abuse by avoiding the storage of high momentum data streams, such as Internet usage data. For example, the network IDS may initially aggregate the raw data stream in a manner that enables network traffic volume to be tracked per server port. If abnormal network activity is detected (or at least suspected) on a particular server port, the aggregation process may be updated to include subscriber identifying information (e.g., a subscriber ID number, source address or port), which may help to identify the particular subscriber(s) responsible for the abusive traffic sent to the busy server port.

As mentioned above and described in more detail below, the network intrusion detection system is able to provide real-time monitoring of high momentum network usage data streams (also referred to herein as “flow record streams”), as well as real-time detection of suspicious or abnormal network activity (i.e., as it occurs). For example, the network IDS may provide a mechanism for obtaining additional information about the abnormal network activity that was not previously collected or analyzed by the system. Such a mechanism would enable real-time investigations into the abnormal activity, such as detecting a type or source of the attack or abuse (i.e., an event or entity responsible for the excessive traffic). The network IDS may also allow sufficient time (if only a matter of seconds) for launching attack countermeasures by providing a reliable means for detecting attack precursors (such as scan operations).

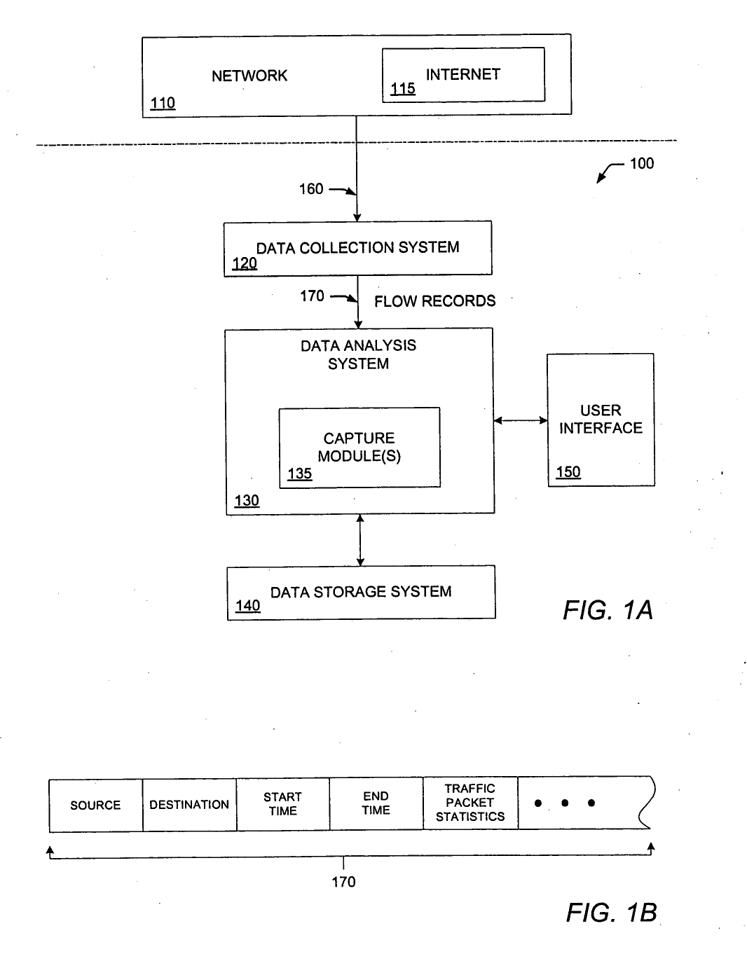

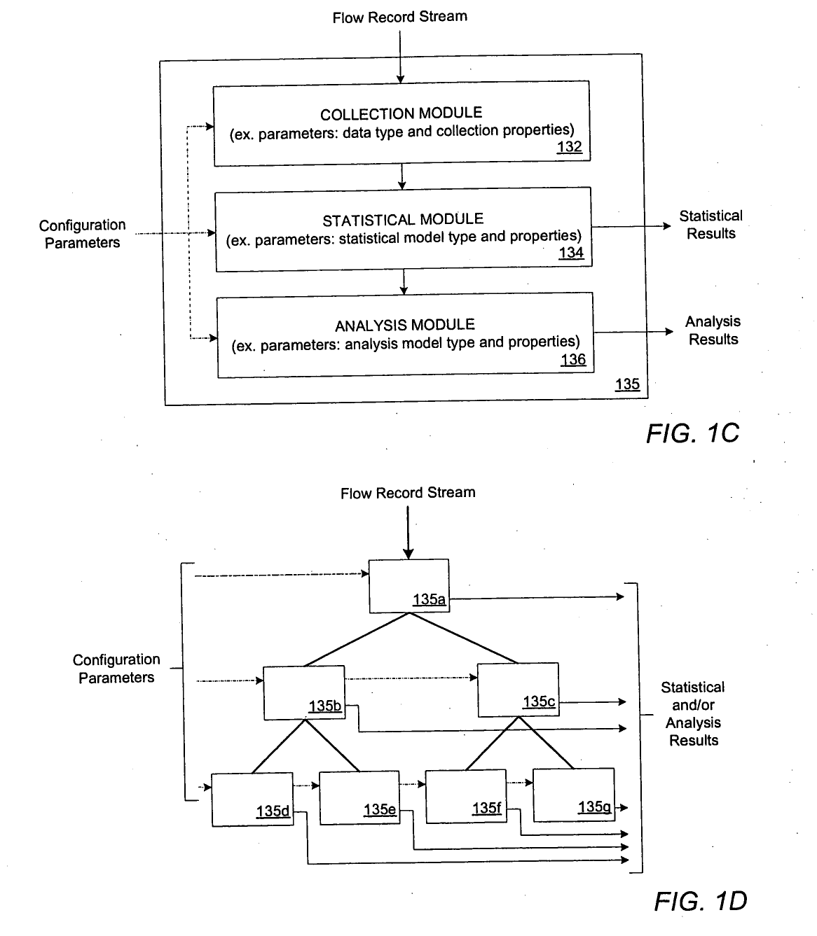

Turning to the drawings, FIG. 1A illustrates one embodiment of a network usage analysis system 100 capable of monitoring and analyzing high momentum network usage data streams in accordance with the present invention. In general, network usage analysis system 100 includes several main components, each of which is a software program. The main software program components of network usage analysis system 100 may run on one or more computer systems. In one embodiment, each of the main software program components runs on its own computer system.

One suitable network usage analysis system for use with the present invention is disclosed in U.S. patent application Ser. No. 09/548,124, filed Apr. 12, 2000, entitled “Internet Usage Analysis System and Method,” and incorporated herein by reference.

In one embodiment, network usage analysis system 100 includes data analysis system 130 and data storage system 140. Data analysis system 130 receives network usage data 170 from data collection system 120, which in turn, receives the network usage data from network 110. In one embodiment, network 110 includes the Internet 115. Preferably, network usage data 170 is a real-time, high momentum stream of network usage data records (otherwise referred to herein as “transactions” or “flow records”). In one embodiment, network usage data 170 is a real-time stream of flow records generated by a network usage data reporting system (not shown) positioned on network 110.

Data analysis system 130 receives the streaming network usage data 170 (in the form of flow records) from data collection system 120 via communication link 160. In one embodiment, data collection system 120 may be included within a network usage data reporting system of network 110. In another embodiment, however, data collection system 120 (and all other system components downstream therefrom) may be coupled to a network usage data reporting system at a location outside of network 110. In other words, network usage analysis system 100 may be implemented at a location physically apart from, though functionally coupled to, network 110. By locating system 100 outside of network 110, network activity can be monitored across all of network 110 without adversely affecting network performance (e.g., without consuming memory or CPU resources on network servers, or otherwise hampering network traffic flow). As such, network usage analysis system 100 may be considered a network-based intrusion detection system, in some embodiments.

Though shown in FIG. 1A as separate from data analysis system 130, data collection system 120 may be a part of data analysis system 130, in another embodiment. One data collection system suitable for use with the present invention is commercially available under the trade name INTERNET USAGE MANAGER, from Hewlett-Packard, U.S.A. Other data collection and reporting systems suitable for use with the network usage analysis system in accordance with the present invention will become apparent to those skilled in the art after reading the present application.

In general, data analysis system 130 may utilize one or more capture modules 135 for monitoring network activity within network 110. In some cases, more than one capture module may be defined to characterize a particular flow record stream in a variety of different ways. Such a case will be described in reference to FIG. 1D.

More specifically, data analysis system 130 utilizes capture module(s) 135 to collect pertinent portions of flow record stream 170 and to generate a statistical result therefrom. In some embodiments, the statistical result may be generated (and possibly stored) as disclosed in U.S. patent application Ser. No. 09/919,149 filed Jul. 31, 2001, entitled “Network Usage Analysis System Having Dynamic Statistical Data Distribution System and Method” and incorporated herein by reference. In some embodiments, the statistical result may also be updated in real-time using a rolling time interval, as described in U.S. patent application Ser. No. 09/919,527 filed Jul. 31, 2001, entitled “Network Usage Analysis System and Method For Updating Statistical Models” and incorporated herein by reference. Other methods for generating, storing and/or updating the statistical result are possible and within the scope of the invention. In some cases, capture module(s) 135 may also be used to analyze the statistical result, regardless of whether the statistical result is stored or not.

In one embodiment, data analysis system 130 is responsive to user interface 150 for interactive analysis of flow record stream 170 using capture module(s) 135. In some cases, user interface 150 may include substantially any input/output device known in the art, such as a keyboard, a mouse, a touch pad, a display screen, etc. In one example, a graphical display of the statistical results may be output to a display screen at user interface 150. In other cases, user interface 150 may comprise a separate computer system, which is coupled by a wired or wireless transmission medium to data analysis system 130.

In one embodiment, data analysis system 130 comprises a computer software program, which is executable on one or more computers or servers for monitoring network activity in accordance with the present invention. The computer software program, including capture module(s) 135, may also be stored in data storage system 140. Though data storage system 140 is shown in FIG. 1A as external to data analysis system 130, data storage system 140 may be included within data analysis system 130, in an alternative embodiment. Data storage system 140 may comprise substantially any volatile memory (e.g., random access memory (RAM)) and/or any non-volatile memory (e.g., a hard disk drive or other persistent storage device) known in the art.

FIG. 1C illustrates the embodiment in which only one capture module 135 is included within data analysis system 130. In particular, capture module 135 includes a collection module 132 for collecting a stream of flow records associated with an observation point within a network. An “observation point” is broadly defined herein as a point of interest in the network.

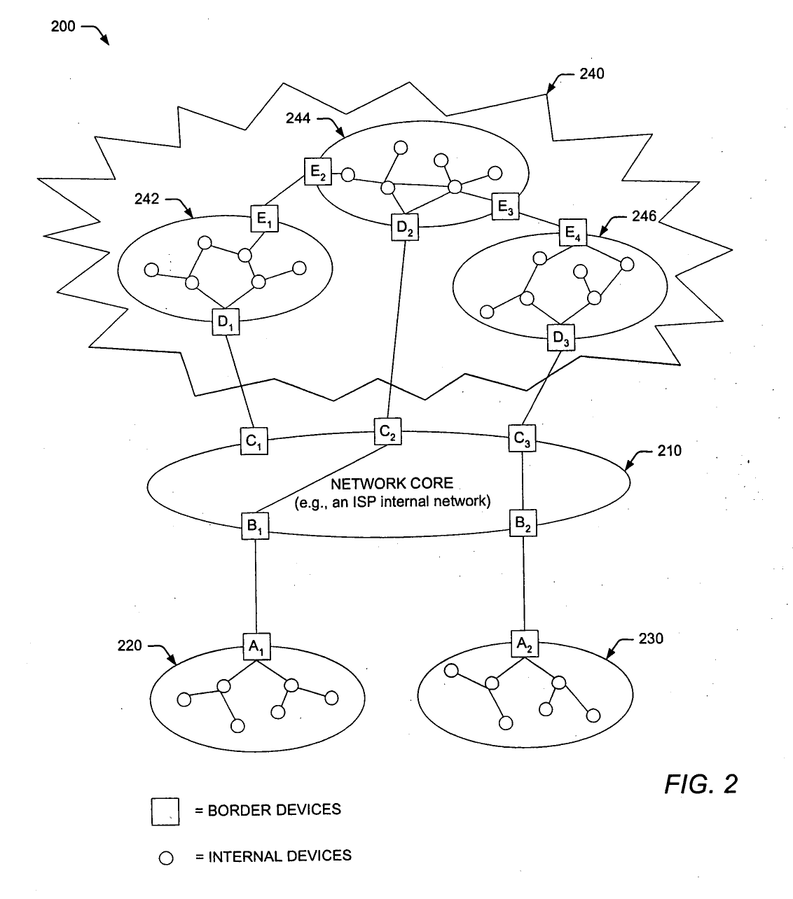

FIG. 2 illustrates one embodiment of a network 200 which may include a network core 210 and a number of sub-networks (e.g., sub-networks 220 and 230). In one example, network core 210 may represent the internal network of an Internet Service Provider (ISP), and sub-networks 220 and 230 may represent the ISP customers. Each of the sub-networks may be coupled to the network core through a network device called an “edge router” (denoted Bᵢ). In some cases, the network core may be further coupled to an external network 240 through one or more network devices called “border routers” (denoted Cᵢ). In one example, the external network may be a wide area network (WAN), such as the Internet, and may include several more sub-networks therein. Although three sub-networks 242, 244, and 246 are illustrated, substantially any number of sub-networks may be included within external network 240. This type of network is generally referred to as a “hierarchical network,” and may contain one or more levels of sub-networks. In an alternative embodiment (not shown), the network may comprise a “flat network” in which there is substantially no distinction between the network core and sub-networks.

In some embodiments, an observation point may include a network device, such those denoted in FIG. 2 as boundary devices (□) and internal devices (∘). As such, an observation point may include a network device, which is arranged on a boundary of the network (e.g., edge routers Bᵢ or border routers Cᵢ and Dᵢ) or a network device arranged within the network (e.g., internal routers Eᵢ, and other internal devices denoted with the symbol, ∘). In other cases, an observation point may include a link, such as a path between two boundary network devices, a path between a boundary network device and an internal network device, or a path between two internal network devices.

Returning to FIG. 1C, collection module 132 may collect the stream of flow records in accordance with a first set of configuration parameters. In general, the first set of configuration parameters may designate a subset of data to be collected from each flow record in the stream, and a time interval over which to collect the subset of data. As will be described in more detail below, the first set of configuration parameters can be modified at any time to obtain additional data from a subsequent flow record stream, if abnormal network activity is indicated in at least a portion of the current flow record stream.

More specifically, the first set of configuration parameters designates one or more types of network usage data to be collected from flow record stream 170. In other words, one or more “fields” or “categories” of network usage data may be collected as the “subset of data.” As shown in FIG. 1B, the flow record fields may contain summarized information about multiple traffic packets. This metadata (i.e., data about data) may include, for example, a source identifier (e.g. a source address or port), a destination identifier (e.g. a destination address or port), a start time and end time, and one or more traffic packet statistics (e.g., the amount of data transferred, such as the number of packets or the number of bytes/packet). In some cases, the flow record fields may contain other metadata, such as the packet protocol used to transfer the data (e.g., TCP or UDP), a packet protocol flag indicator, an input interface index, an output interface index, and a type of service, among other types of information. In some cases, the volume of network usage data collected can be greatly reduced by selecting only a few types of network usage data (or flow record fields) from each flow record in the stream.

As noted above, the first set of configuration parameters may also designate a time interval over which to collect the subset of data. In some cases, the time interval may be selected from a range of programmable time values extending between about one second and about 30 days (or more). In other cases, the range of programmable time values may be on the order of minutes to days. Alternatively, or in addition to specifying the length of time over which to collect the subset of data, the time interval may specify the length of time over which one or more statistical models are applied to the selected subset of data for generating statistical results therefrom. As such, the first set of configuration parameters may further designate a time interval type (e.g., fixed or rolling time intervals) for statistically analyzing the subset of data collected during the time interval. In brief, a fixed time interval would generate a statistical result of the collected subset of data around the end of the time interval; whereas a rolling time interval would generate and continuously update the statistical result over the duration of the time interval.

In one embodiment, collection module 132 may supply the first set of configuration parameters to data collection system 120 to specify the length of time over which data collection system 120 is to collect a particular subset of data from a network usage data reporting system. In an alternative embodiment, however, collection module 132 may retain the first set of configuration parameters without supplying them to data collection system 120. In other words, data collection system 120 may receive a real-time stream of flow records (containing, e.g., individual flow records or flow records that have been grouped and summarized), which are “flushed” from a temporary data storage location (usually RAM) within the network usage data reporting system at regular and frequent intervals. These “flushing intervals” are generally dependent on characteristics of the particular reporting system supplying the streams; therefore, the flushing intervals may be substantially instantaneous, or may range from mere seconds to several days (depending, e.g., on the amount of temporary storage space available within the particular reporting system). The time interval designated by the first set of configuration parameters may then be used by collection module 132 for collecting the specified subset of data from the stream of flow records received by data collection system 120.

Capture module 135 also includes a statistical module 134 for generating a statistical result of the subsets of data collected from the flow record stream. In some cases, statistical module 134 may use the time interval specified by the first set of configuration parameters to generate the statistical result. For example, statistical module 134 may generate the statistical result at the end of the time interval, or alternatively, during the time interval as each subset of data is collected from the stream of flow records.

However, the actual generation of the statistical result may be conducted in accordance with a second set of configuration parameters. In general, the second set of configuration parameters designates a type of statistical model to be used for generating the statistical result, in addition to one or more properties associated with the designated type of statistical model. As will be described in more detail below, the second set of configuration parameters can be modified at any time after system initialization to generate a statistical result on a subsequent flow record stream, if abnormal network activity is indicated in at least a portion of the current record event stream.

More specifically, the second set of configuration parameters designates a particular type of statistical model to be used for characterizing the subset of data collected from the flow record stream. In one embodiment, the type of statistical model may be selected from a group comprising a histogram (i.e., a distribution), the top N occurrences of a variable (i.e., a TopN distribution) and a time series of occurrences of the variable (i.e., a time series plot). Other statistical model types may be included depending on the network usage related problem to be solved. Exemplary statistical model types that may be used to solve a particular network usage related problem (such as, e.g., the detection of scan traffic or subscriber abuse) will be described in more detail below.

In addition to statistical model type, the second set of configuration parameters designates one or more statistical model properties, such as whether the statistical result is to be generated as a linear or log distribution, in addition to the number and/or width of bins to be created for the distribution. In some cases, the statistical result may be generated dynamically by creating the bins in real-time and on an “as-needed-basis” (or “on-the-fly”) based on the values of the incoming data stream. The resultant distribution may then be output to user interface 150 for current analysis and/or stored in memory for future analysis.

In some embodiments, capture module 135 may also include an analysis module 136 for analyzing the statistical result generated by statistical module 134. As such, the analysis result and/or the statistical result may be used for monitoring, the network activity associated with the observation point. In some cases, analysis module 136 may analyze the statistical result upon completion of the time interval specified by the first set of configuration parameters. In other cases, however, analysis module 136 may be configured for analyzing statistical results that have been stored in memory.

In any case, analysis of the statistical result may be conducted in accordance with a third set of configuration parameters. The third set of configuration parameters may designate a type of analysis model to be used for analyzing the statistical result, in addition to one or more properties associated with the designated type of analysis model. As will be described in more detail below, the third set of configuration parameters can be modified at any time after system initialization to reanalyze a previous statistical result (or analyze a statistical result of a subsequent flow record stream), if abnormal network activity is indicated in at least a portion of the current flow record stream.

More specifically, the third set of configuration parameters designates a particular type of analysis model to be used for monitoring network activity. In one embodiment, the type of analysis model may be selected from a group comprising the statistical result, a normalized version of the statistical result, a probability density function of the statistical result, and a cumulative density function of the statistical result. Other types of analysis models may be included depending on the network usage related problem to be solved. Exemplary types of analysis models that may be used to solve a particular network usage related problem (such as, e.g., the detection of scan traffic or subscriber abuse) will be described in more detail below.

In addition to the type of analysis model, the third set of configuration parameters may designate one or more analysis model properties, such as a threshold value, a slope value or a shape, each of which may be associated with either “normal” or “abnormal” network activity. For example, the analysis results may indicate an occurrence of abnormal network activity upon exceeding a particular threshold or slope value. Alternatively, abnormal network activity may be indicated if a shape of the current analysis results deviates significantly from a shape of analysis results known for characterizing so-called “normal” network activity. In any case, the analysis results may be output to user interface 150 for current observation and/or stored in memory for future observation.

In one embodiment, the statistical result may be analyzed “automatically” by additional computer program instructions, or “manually” by a user of the network usage analysis system. For example, the statistical result may be graphically (or otherwise) displayed on a display screen at user interface 150. As such, the user (and/or the computer program instructions) may use the statistical result for 1) monitoring and/or detecting various network usage “characteristics” or “behaviors,” or 2) selecting an analysis model for further analysis of the displayed statistical results. Alternatively, the analysis results may be automatically generated by the additional computer instructions and graphically (or otherwise) displayed on the display screen in lieu of the statistical results. In this manner, the analysis results may be used for monitoring network activity and detecting abnormal network activity therefrom.

The displayed (statistical and/or analysis) results may also be used for performing interactive analysis of the network usage data via user interface 150. In other words, user interface 150 may accept user commands for modifying any of the first, second or third sets of configuration parameters. As noted above, the first, second and third sets of configuration parameters can be modified at any time after system initialization to collect, generate and/or analyze a subsequent stream of flow records in a different manner. For example, one or more of the configuration parameters may be modified after abnormal activity is initially detected, so that a subset of the network activity corresponding to the abnormal activity can be subsequently collected, generated and/or analyzed in much greater detail.

Unlike other systems, the present system is able to dynamically modify the configuration parameters without the need to shut down or temporarily suspend system operations. Such dynamic modification may alter a magnification level by which the subset of network activity is subsequently monitored. As will be described in more detail below, the magnification level may be altered, in some cases, to determine whether the observation point is responsible for the detected abnormal network activity (i.e., whether the observation point is a “source” of the abnormal network activity).

FIG. 1D illustrates an embodiment in which multiple capture modules 135 are included within data analysis system 130. In some cases, capture modules 135 may be arranged in a hierarchy or tree structure, such that an output of a higher level capture module (e.g., capture module 135a) may be input to a lower level capture module (e.g., capture module 135b or 135c) at the end of a specified time interval (which may, or may not, correspond to the time interval specified by the first set of configuration parameters). FIG. 1D illustrates a binary tree structure merely for the purpose of simplicity; alternative structures and configurations may be applicable.

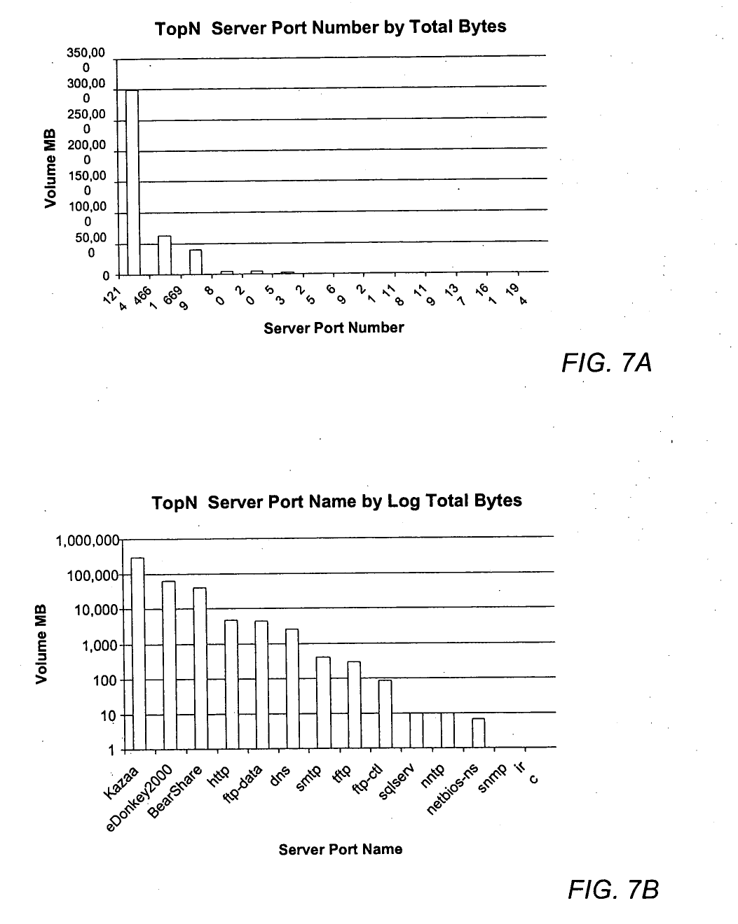

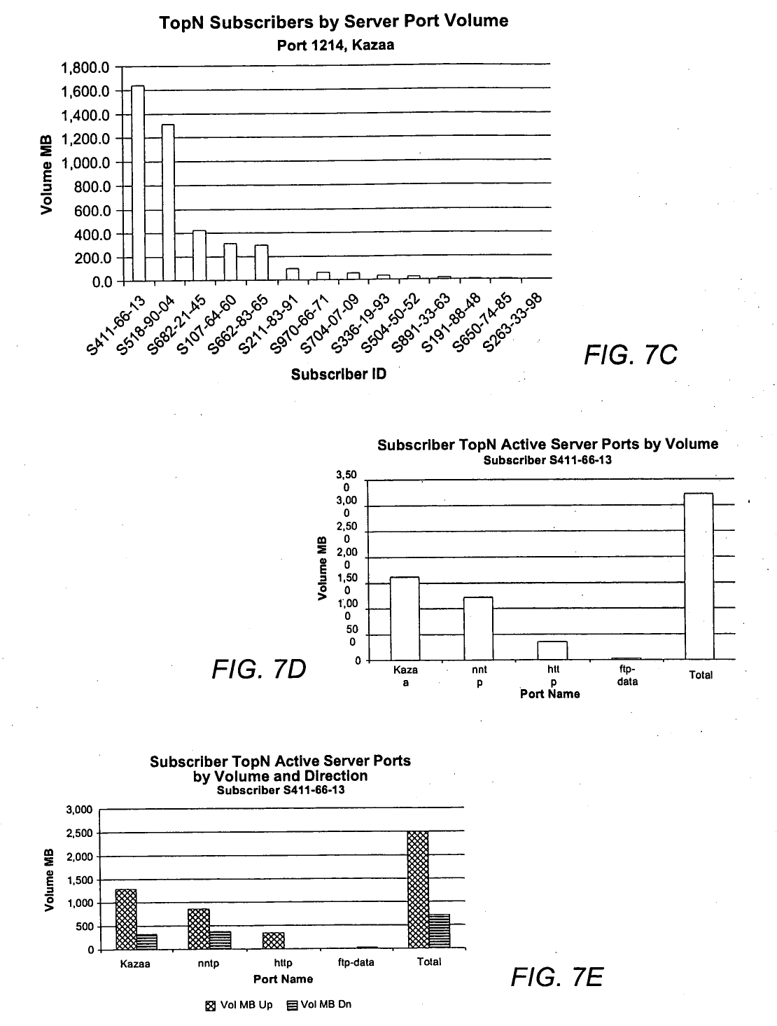

In general, each of the capture modules shown in FIG. 1D includes a collection module 132, a statistical module 134 and an analysis module 136, as described above in reference to FIG. 1 C. However, one or more of the capture modules of FIG. 1D may be independently configured for characterizing a current flow record stream in a slightly different manner. For example, a higher level capture module may generate a distribution of the traffic volume per destination server port number (FIG. 7A), whereas a lower level capture module may generate a distribution of the traffic volume per subscriber on a particular server port number (FIG. 7C). Such independent configuration may enable multiple “views” to be obtained from a single stream of flow records associated with a particular observation point.

In addition to independent configuration, one or more capture modules of FIG. 1D may be dynamically reconfigured for characterizing a subsequent flow record stream (or possibly, a current flow record stream) in a slightly different manner. In some cases, a higher level capture module may be reconfigured for collecting additional data from a subsequent flow record stream, if abnormal network activity is indicated from results obtained by a lower level capture module on a current (or previous) flow record stream. For example, assume that a higher level capture module (e.g., capture module 135a) is initially configured for collecting the destination server port number and packet volume from each flow record in the stream. However, if results from a lower level capture module (e.g., capture module 135f) indicate abnormal activity on one or more destination server port numbers, the higher level capture module may be reconfigured to also collect, e.g., the subscriber ID numbers. The lower level capture module may also need to be reconfigured to accept the newly collected subscriber ID numbers. Therefore, the collection of additional data is generally achieved by selecting a different set of configuration parameters for collection module(s) 132 within one or more levels of capture modules 135.

In some cases, a higher level capture module may be reconfigured for generating a new statistical result of a subsequent flow record stream, if abnormal network activity is indicated from results obtained by a lower level capture module on a current (or previous) flow record stream. In some cases, new statistical results may be generated by performing the reconfiguration process in reverse. For example, a lower level capture module may be dynamically reconfigured for generating a new statistical result, if the statistical results from a higher level capture module provide indication of abnormal network activity. Therefore, the generation of new statistical results is generally achieved by selecting a different set of configuration parameters for the statistical module(s) 134 within one or more levels of capture modules 135.

In some cases, a higher level capture module may be reconfigured for analyzing a subsequent statistical result in a different manner, if abnormal network activity is indicated from results obtained by a lower level capture module on a current (or previous) flow record stream. In some cases, new analysis results may be generated by performing the reconfiguration process in reverse. For example, a lower level capture module may be dynamically reconfigured for analyzing a current statistical result, if the analysis results from a higher level capture module provide indication of abnormal network activity. Therefore, the generation of new analysis results is generally achieved by selecting a different set of configuration parameters for the analysis module(s) 136 within one or more levels of capture modules 135.

In this manner, multiple capture modules 135 may be used for generating a plurality of statistical and/or analysis results. At any level of the tree structure, the results may be sent to a display device for current observation or analysis, to a storage device for future observation or analysis, or to a lower level capture module for further processing.

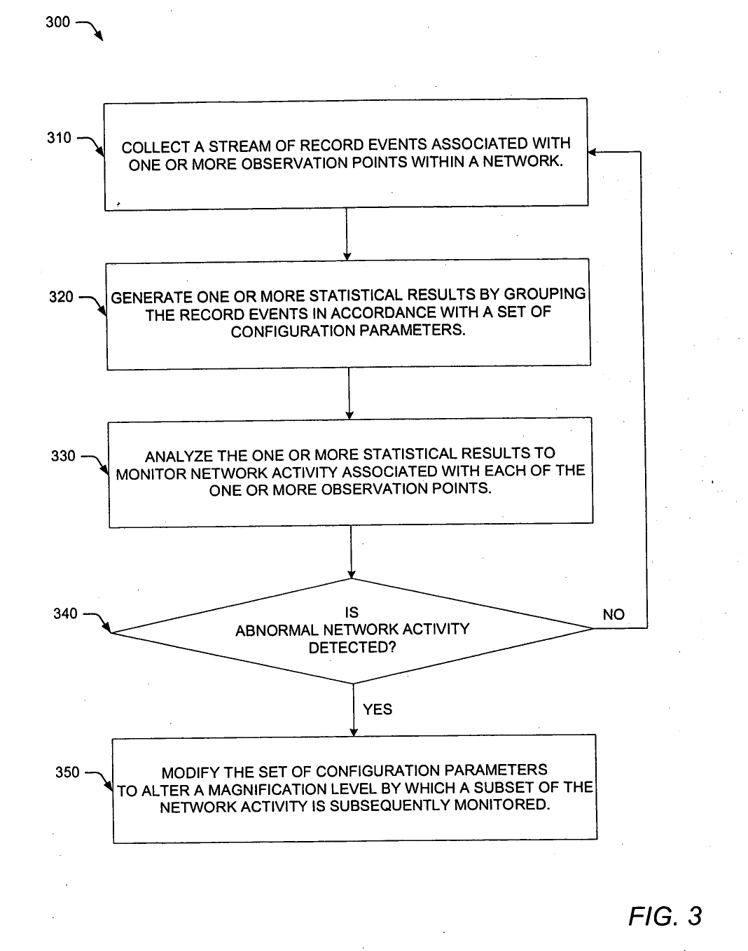

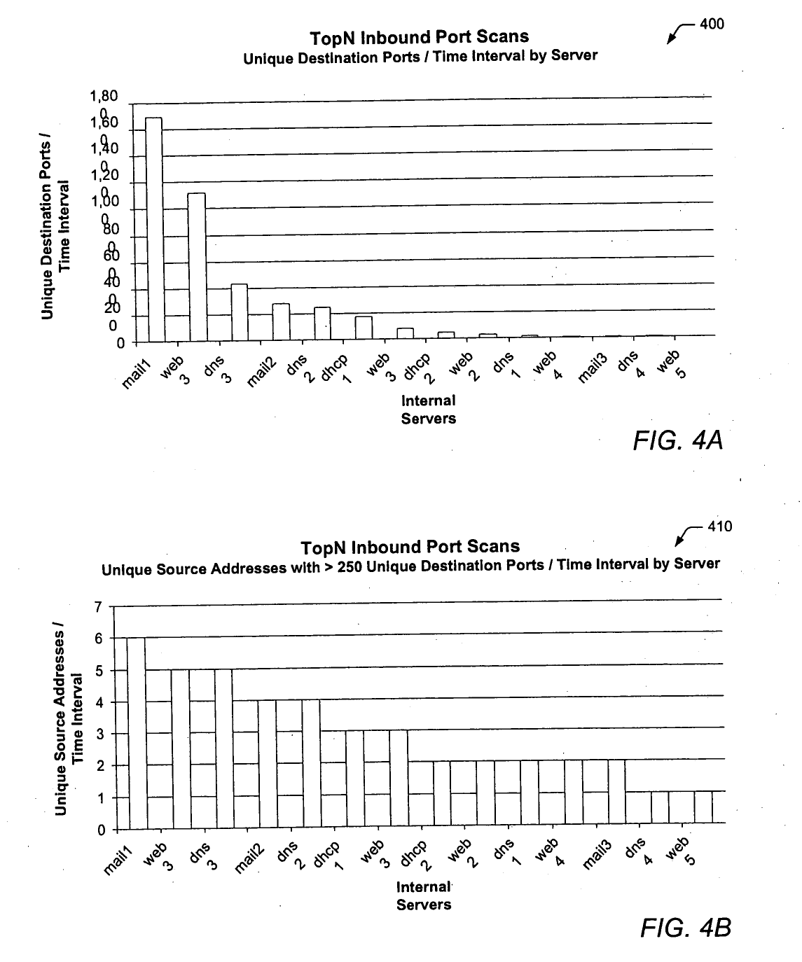

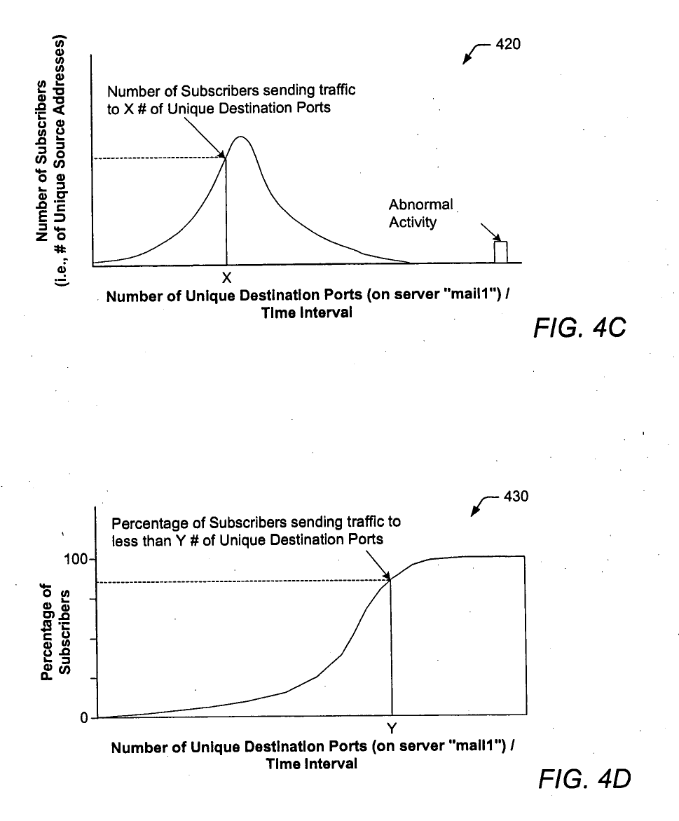

A computer-executable method 300 for detecting abnormal network activity will now be described in reference to FIGS. 3 and 4. In some embodiments, method 300 may be used for isolating a source of the abnormal activity. In general, method 300 is performed by network usage analysis system 100, as described above in FIGS. 1 and 2. As such, method 300 is implemented as computer-executable program instructions, which may be stored within a data storage device, transferred over a transmission medium, and executed by a processing device, of system 100.

As shown in FIG. 3, the method may begin in box 310 by collecting a stream of flow records associated with one or more observation points within a network. As noted above, an observation point may comprise a network device arranged within the network (i.e., an “internal network device”), a network device arranged on boundary of the network (i.e., a “boundary network device”), or a link arranged between two network devices. In some cases, an observation point may further comprise a computer system or server arranged within, or merely coupled to, the network.

In a specific embodiment, the stream of flow records are collected from one or more boundary network devices (e.g., edge or border routers). In other words, the present method may avoid collecting duplicate flow record streams by “metering at the edges” of the network (i.e., by collecting flow record streams where traffic originates or terminates), thereby reducing the over-all volume of data collected. However, such an embodiment should not be interpreted to limit the location of observation points to the network boundary. Instead, metering at the edges enables the flow record streams to be obtained from any number of observation points (e.g., from one to thousands of points) located substantially anywhere within the network. In addition, multiple flow record streams may be simultaneously obtained from any number of observation points at substantially any time of day (i.e., regardless of network usage), without adversely affecting network performance.

As noted above, the stream of flow records may be collected by data collection system 120 (or alternatively, by collection module 132) during a first time interval. In one embodiment, the collection system or module may be configured for collecting only the portions of the flow records that are relevant to a particular statistical module 134. In one example, the only portions (i.e., “subset of data”) collected during the first time interval may be a source identifier (e.g., a source address) and/or a destination identifier (e.g., a destination port). As a result, the over-all volume of data collected may be greatly reduced by collecting only a subset of data from each flow record in the stream. In an alternative embodiment, however, the entire flow record (and possibly portions of the traffic packet data) may be collected for future analysis.

In box 320, one or more statistical results are generated by grouping the flow records (or collected portions thereof in accordance with a set of configuration parameters. The flow records (or collected portions thereof) may also be grouped by observation point if network activity is to be monitored at more than one observation point. The set of configuration parameters may specify the subset of data to be collected from each flow record in the stream and the first time interval (over which to collect the subset of data). In addition, the set of configuration parameters may also designate a type of statistical model to be used for generating the statistical results, as well as one or more properties associated with the designated type of statistical model.

For example, in one embodiment, only the destination port may be collected from each flow record during the first time interval. In such an embodiment, a distribution may be chosen to characterize the number of unique destination ports addressed (per server) during the first time interval. FIG. 4A illustrates an exemplary statistical result (400) in which only the top N internal servers are displayed, based on the number of unique destination ports (or, unique ports local to each server) addressed during the first time interval. In some cases, statistical result 400 may be used for monitoring the network traffic sent to each of the top N servers during the first time interval. As a result, statistical result 400 could be used for detecting abnormal network activity that may occur during the first time interval. In the embodiment of FIG. 4A, for example, an automated scan for open ports (i.e., a port scan) on servers “mail1” and “web3” may be suspected, due to the abnormally high volume of traffic sent to servers “mail1” and “web3” during the first time interval.

In another embodiment, the source address and the destination port may be collected from each flow record during the first time interval. A distribution may be chosen to characterize the number of unique source addresses, which are sending traffic to a relatively large number of unique destination ports during the first time interval. FIG. 4B illustrates an exemplary statistical result (410) displaying the number of unique source addresses that are sending network traffic to more than 250 unique destination (or local) ports on each of the top N servers. If statistical result 410 is used for monitoring network activity, one may suspect that up to six sources may be sending scanning traffic to servers “mail1” and “web3.”

In box 330, the statistical results are analyzed for monitoring network activity associated with the one or more observation points (e.g., the Top N servers). As mentioned above, the statistical results may be analyzed, in some cases, by noting characteristics of the statistical results that appear to be suspicious or abnormal (recall, the high traffic volume sent to servers “mail1” and “web3”). In other cases, however, the statistical results may be manipulated to produce so-called “analysis results,” which may then be used for monitoring network activity associated with one or more of the observation points. In one example, analysis results may be generated by applying a density function to the statistical results (e.g., a probability or cumulative density function as shown in FIGS. 4C and 4D, respectively). In such an example, network activity can be monitored by comparing the analysis results to a predefined, though possibly reconfigurable, benchmark value.

In some cases, abnormal network activity may be detected from the analysis results if the amount of network activity sent to (or from) an observation point exceeds a predefined threshold value. The threshold value may be selected “automatically” by additional computer program instructions, or “manually” by a user of the network usage analysis system, and may be subsequently changed or updated, as desired. The present invention eliminates any guesswork used in conventional methods (which may select a fixed threshold value based on personal experience, rule-of-thumb, etc.) by designating the threshold value as a percentage of the total network activity sent to (or from) the observation point. In this manner, the threshold value may be chosen regardless of distribution shape; thus, no assumptions have to be made concerning whether the variable of interest (e.g., network activity) is normally distributed, or distributed by any other mathematically derived means.

In other cases, abnormal network activity may be detected if a characteristic of the analysis results deviates significantly from a characteristic known for its association with “normal” network activity. In one example, network activity may be monitored by observing a shape (i.e., an envelope) of the analysis results. In such an example, abnormal network activity may be detected if the observed shape deviates significantly (e.g., more than 5-20% deviation) from a predetermined shape known for its association with “normal” network activity. In another example, network activity may be monitored by calculating an area under the envelope, or by measuring a slope of the analysis results at a location of interest. As such, abnormal network activity may be detected if the calculated area or the measured slope deviates significantly from predetermined area and slope values known for their association with “normal” network activity. It is noted that methods other than those described above may also be used for detecting abnormal activity.

Note that the terms “normal network activity” and “abnormal network activity” are used in a relative sense. Any particular values or characteristics of network activity, which may be distinguished as either “normal” or “abnormal,” are generally dependent on the network activity being monitored, as well as other factors, such as the time of day such monitoring occurs. However, one of ordinary skill in the art would be able to determine appropriate values or characteristics, which correspond to “normal” or “abnormal” network activity as it relates to a particular application, in light of the disclosure provided herein and without undue experimentation.

For example, network activity can be monitored to establish normative behaviors for different times of the day, different days of the week, etc. The normative behaviors may then be used to determine a benchmark value (e.g., a threshold, slope, or shape), or possibly several benchmark values corresponding to different times, days, etc. By storing the benchmark value(s) in memory, subsequent network activity can be monitored without the need for storing the previously established normative behavior (i.e., previous statistical or analysis results) for comparison purposes. By storing the benchmark value(s), in lieu of the statistical or analysis results, the present method significantly reduces storage and processor requirements placed on the present system. However, the statistical or analysis results may also be stored, if desired.

FIG. 4C illustrates an embodiment in which analysis result 420 is produced by applying a probability density function to the data initially collected for generating statistical result 410. As such, analysis result 420 illustrates the number of subscribers (i.e., designated by unique source addresses), which are contributing traffic to each of the unique destination ports on a particular server (e.g., server “mail1”) during the first time interval. In the embodiment of FIG. 4C, a port scan may be suspected if a spike of activity is observed, e.g., around the 99^{th} percentile of the total number of destination ports.

FIG. 4D illustrates an embodiment in which analysis result 430 is produced by applying a cumulative density function to the data initially collected for generating statistical result 410. As such, analysis result 430 illustrates the percentage of subscribers (i.e., designated by unique source addresses), which are contributing traffic to less than a particular number of unique destination ports on a particular server (e.g., server “mail1”) during the first time interval. In the embodiment of FIG. 4D, abnormal activity may be detected, for example, if the percentage of subscribers contributing traffic to less than 10 unique destination ports decreases from about 95% to about 80%. In other words, the percentage of subscribers contributing traffic to more than 10 unique destination ports has increased from about 5% to about 20%.

It may not be feasible to record all dimensions of a high momentum data stream (e.g., a flow record stream), due to the high volume and speed at which the data stream would be presented to a storage system, as well as the high cost of such massive storage. Therefore, after establishing normative behaviors or characteristics of the high momentum data stream, the present method provides an inventive technique for dynamically exploring certain deviations from those norms without requiring the data stream to be stored. Though this technique may be somewhat ineffective for discovering once-in-a-lifetime events, it is ideal for detecting and exploring patterns in a stream. Fortunately, many types of network activity can be characterized as patternistic behavior. Examples of such network activity include several types of attack (e.g., flood attacks), abuse (e.g., subscriber-run servers), and theft (e.g., address spoofing), in addition to activity unrelated to network security (e.g., network congestion). Due to the repetitive nature of patterns, the technique enables suspect or abnormal network activity to be further explored at some point in the future. Since exploration occurs as we move forward in time, not backward, the technique is referred to herein as “Drill Forward.”

For the purposes of this discussion, the term “Drill Forward” refers to the process of obtaining additional information (e.g., higher granularity data) about a particular observation point (e.g., a particular network node, host server, or subscriber) from a real-time stream of flow records AFTER analysis of data previously collected from the stream causes one to become suspicious of the observation point. Generally speaking, the Drill Forward technique enables real-time investigation into abnormal network activity by allowing real-time modification of capture module configuration parameters. Though the Drill Forward technique has been described in the context of network security, the technique may be applied to investigate any other area of network usage.

If abnormal activity is detected in box 340, the set of configuration parameters can be modified in box 350 to alter a magnification level by which a subset of the network activity is subsequently monitored. This subset is generally associated with the abnormal activity detected in box 340. If no abnormal activity is detected, however, the magnification level can be maintained (or adjusted, as desired) while the process of collecting, generating, analyzing and detecting is repeated (in box 310) for a subsequent stream of flow records.

In some cases, the “magnification level” may be altered to characterize a subsequent stream of flow records (i.e., flow records obtained during a subsequent time interval) in a slightly different manner. For example, statistical result 410 may have been generated after modifying the set of configuration parameters to collect additional data (e.g., to collect the source address) from a subsequent stream of flow records, in addition to the destination port collected to generate statistical result 400. As a result, the subsequent stream of flow records may be collected, and thus, a subsequent plurality of statistical results may be generated, in greater detail than they were previously collected and generated. In some cases, the type of abnormal network activity may be determined by altering the magnification level.

In other cases, however, the “magnification level” may be altered to focus on a particular subset of the flow record stream where the abnormal network activity occurred. For example, abnormal activity may be detected (or at least suspected) from analysis result 430. To obtain a better view of the abnormal activity, the set of configuration parameters may be modified to focus on the subset of subscribers sending traffic to the greatest number of unique destination ports. For example, the set of configuration parameters may be modified to collect subscriber ID numbers, in addition to the flow record fields previously collected. As a result, a particular subscriber or subset of subscribers may be determined to be a source of the abnormal network activity.

In some cases, however, it may be necessary to repeat the steps of collecting (box 310), generating (box 320), analyzing (box 330) and modifying (box 340) over one or more consecutive time intervals in order to successfully isolate the source of abnormal network activity to one or more of the observation points (i.e., to one or more subscribers, in the current example). Unlike many conventional techniques, however, the present method enables a source of the abnormal network activity to be isolated without utilizing additional network resources, such as network probes and traces.

As described above, the present method provides real-time detection and investigation of abnormal network activity. In the realm of network security, for example, the present method may be used for detecting event precursors (e.g., port or address scans), which may provide early indication of an upcoming attack. Such early indication may enable a network technician to minimize the amount of damage inflicted by the attack, or possibly, to prevent the upcoming attack from occurring. In addition, the present method may be used to provide real-time detection of various types of attacks, abuse, fraud and theft by configuring the capture modules in an appropriate manner.

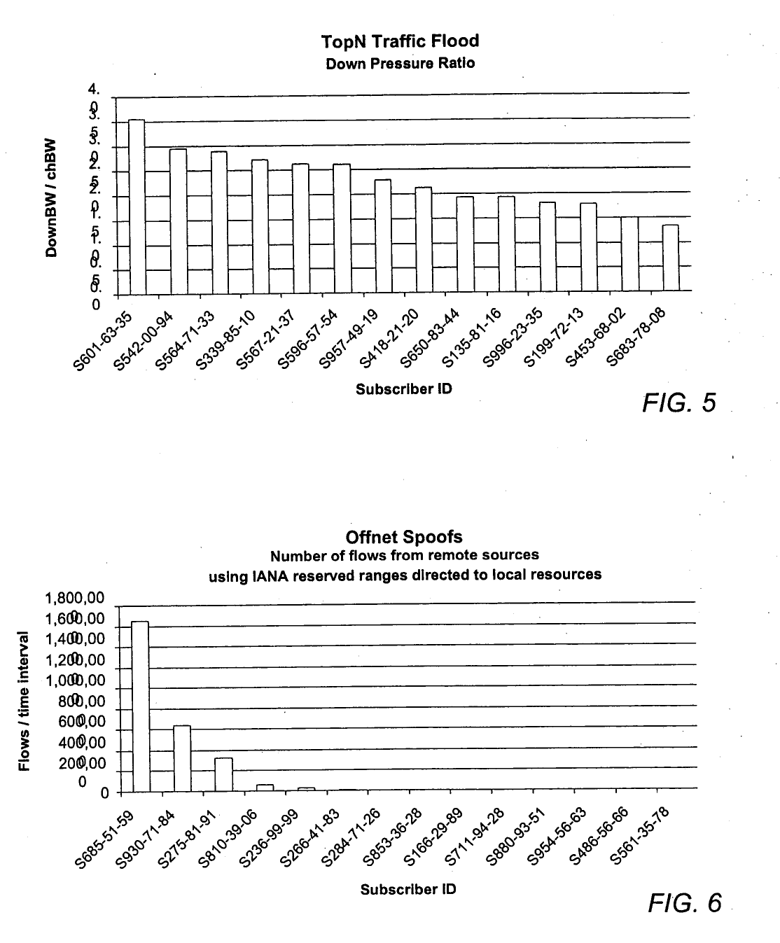

In one example, FIG. 5 illustrates exemplary statistical results that may be used for detecting flood attacks. In particular, FIG. 5 plots the ratio of offered load to channel capacity for the Top N subscriber IDs. A ratio of greater than about 1.0 for any sustained period may indicate the occurrence of a flood attack.

In another example, FIG. 6 illustrates exemplary statistical results that may be used for detecting an abusive process called “address spoofing,” where the sending party disguises their own IP address by changing it to some other address. In the example of FIG. 6, the number of flows to a network resource may be tracked, where the source IP address has been spoofed to an address within the Internet Assigned Numbers Authority (IANA) reserved address blocks. Since no one, other than the IANA, is allowed access to these reserved address blocks, a large number of flows to an IANA address may indicate the occurrence of address spoofing.

In yet another example, FIGS. 7A-7E illustrate exemplary statistical results that may be used for detecting subscriber bandwidth abuse. As noted above, many Service Providers have end-user-agreements that forbid the use of subscriber-run servers. FIG. 7A is a graph illustrating the Top N subscriber server ports sorted by traffic volume. FIG. 7B is the same information represented differently (i.e., by changing the statistical model property to a logarithmic distribution) for better viewing of the lower ranked ports. FIGS. 7A and 7B highlight the subscriber server ports that are creating the highest volume of traffic on the network.

Now that we have a prioritized list of the most troublesome server ports, the Top N subscribers contributing to the traffic on a particular server port (e.g., Port 1214, Kazaa) may be isolated, as shown in FIG. 7C, by dynamically reconfiguring one or more capture modules after the next time interval. Now that a small subset of subscribers have been identified as the source of traffic on a few server ports, the capture modules can be dynamically reconfigured once more to investigate a particular subscriber, as shown in FIGS. 7D and 7E. FIG. 7D shows the TopN active server ports by volume for the subscriber (S411-66-13) found to be contributing the most traffic volume in FIG. 7C. FIG. 7E shows the TopN active server ports by volume and direction for subscriber S411-66-13.

Program instructions implementing methods such as those described above may be transmitted over or stored on a carrier medium. The carrier medium may be a transmission medium such as a wire, cable, or wireless transmission link, or a signal traveling along such a wire, cable, or link. The carrier medium may also be a storage medium such as a read-only memory, a random access memory, a magnetic or optical disk, or a magnetic tape.

In an embodiment, a processor may be configured to execute the program instructions to perform a computer-executable method according to the above embodiments. The processor may take various forms, including a personal computer system, mainframe computer system, workstation, network appliance, Internet appliance, personal digital assistant (“PDA”), television system or other device. In general, the term “computer system” may be broadly defined to encompass any device having a processor, which executes instructions from a memory medium.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), or other technologies or methodologies, as desired.

The above discussion is meant to be illustrative of the principles and various embodiments of the present invention. Numerous variations and modifications will become apparent to those skilled in the art once the above disclosure is fully appreciated. Though a system and method were described primarily in the context of network security, the system and method could be used for detecting substantially any pattern of network “usage,” “activity,” “characteristic” or “behavior.” For example, the system and method could be used for detecting sources of network congestion. It is intended that the following claims be interpreted to embrace all such variations and modifications.

1. A system, coupled to a network, the system comprising:
a collection module for collecting a stream of flow records from an observation point within the network, wherein the stream of flow records is collected in accordance with a first set of configuration parameters;
a statistical module for generating a statistical result from the stream of flow records as each flow record is collected, wherein the statistical result is generated in accordance with a second set of configuration parameters;
an analysis module for analyzing the statistical result to monitor network activity associated with the observation point, wherein the statistical result is analyzed in accordance with a third set of configuration parameters; and
wherein the first, second, and third sets of configuration parameters can be modified at any time, after abnormal activity is detected by the analysis module, to alter a magnification level by which a subset of the network activity is subsequently monitored.

2. The system as recited in claim 1, wherein the subset of network activity corresponds to a portion of the network activity where the abnormal activity occurred.

3. The system as recited in claim 2, further comprising one or more capture modules, each encapsulating the collection module and at least one of the statistical and analysis modules, wherein the one or more capture modules are implemented with computer-executable program instructions.

4. The system as recited in claim 3, wherein the system further comprises a data storage device for storing the computer-executable program instructions and a processing device for executing the computer-executable program instructions.

5. The system as recited in claim 1, wherein a user interface coupled to the system is configured for graphically displaying at least one of the statistical result and an analysis result thereof, and accepting user commands for modifying the first, second and third sets of configuration parameters.

6. The system as recited in claim 1, wherein the collection module is configured for collecting the stream of flow records from a network device arranged on the network and associated with the observation point.

7. The system as recited in claim 6, wherein the observation point comprises the network device.

8. The system as recited in claim 6, wherein the observation point comprises an additional network device arranged within the network.

9. The system as recited in claim 6, wherein the observation point comprises a link arranged between the network device and the additional network device.

10. The system as recited in claim 1, wherein the first set of configuration parameters designates a subset of data to be collected from each flow record in the stream, and a time interval over which to collect the subset of data.

11. The system as recited in claim 10, wherein the subset of data corresponds to one or more record event fields selected from a group comprising a source identifier, a destination identifier, a start time, an end time, and one or more traffic statistics.

12. The system as recited in claim 10, wherein the time interval is selected from a range of programmable time values extending between about one second and about thirty days.

13. The system as recited in claim 10, wherein the statistical module is configured for generating the statistical result during the time interval as each subset of data is collected from the stream of flow records.

14. The system as recited in claim 13, wherein the second set of configuration parameters designates a type of statistical model to be used for generating the statistical result, in addition to one or more properties associated with the designated type of statistical model.

15. The system as recited in claim 13, wherein the analysis module is configured for analyzing the statistical result upon completion of the time interval.

16. The system as recited in claim 15, wherein the third set of configuration parameters designates a type of analysis model to be used for analyzing the statistical result, in addition to one or more properties associated with the designated type of analysis model.

17. The system as recited in claim 1, wherein the magnification level is altered by modifying at least one of the first, second and third configuration parameters to respectively collect, generate or analyze a subsequent stream of flow records in a different manner.

18. A computer-executable method for isolating a source of abnormal network activity, the method comprising:
collecting a stream of flow records associated with a plurality of observation points within a network during a first time interval;
generating a plurality of statistical results by grouping the flow records, as each flow record is collected, by observation point and in accordance with a set of configuration parameters;
analyzing the plurality of statistical results upon completion of the first time interval to monitor network activity associated with each of the plurality of observation points;
modifying the set of configuration parameters, if abnormal network activity is detected during the step of analyzing, to alter a magnification level by which a subset of the network activity is subsequently monitored; and
repeating the steps of collecting, generating, analyzing, and modifying over one or more consecutive time intervals until the source of the abnormal network activity is isolated to one or more of the plurality of observation points.

19. The computer-executable method as recited in claim 18, wherein the plurality of observation points comprises a plurality of network devices arranged within the network, on a boundary of the network, or both.

20. The computer-executable method as recited in claim 19, wherein the plurality of observation points further comprises a plurality of links arranged between the plurality of network devices.

21. The computer-executable method as recited in claim 18, wherein the set of configuration parameters designates a subset of data to be collected from each flow record in the stream, the first time interval over which to collect the subset of data, a type of statistical model to be used for generating the statistical results, and one or more properties associated with the designated type of statistical model.

22. The computer-executable method as recited in claim 18, wherein said analyzing generates a plurality of analysis results by calculating a density function for each of the plurality of statistical results.

23. The computer-executable method as recited in claim 22, wherein said analyzing monitors network activity by comparing the plurality of analysis results to a predefined threshold value.

24. The computer-executable method as recited in claim 22, wherein said analyzing monitors network activity by comparing the plurality of analysis results to a predefined shape.

25. The computer-executable method as recited in claim 22, wherein said analyzing monitors network activity without requiring previous statistical or analysis results to be stored for comparison purposes.

26. The computer-executable method as recited in claim 18, wherein said modifying enables a subsequent stream of flow records to be collected and a subsequent plurality of statistical results to be generated in greater detail than they were previously collected and generated.

27. A computer-usable medium, comprising:
a first set of program instructions executable on a computer system for collecting a stream of flow records from a plurality of observation points within a network;
a second set of program instructions executable on a computer system for generating a plurality of statistical results by grouping the flow records, as each flow record is collected, by observation point and in accordance with a set of configuration parameters;
a third set of program instructions executable on a computer system for analyzing the plurality of statistical results to monitor network activity associated with each of the plurality of observation points; and
wherein any of the first, second and third program instructions can be programmably reconfigured at any time, after abnormal activity is detected by the third set of program instructions, to alter a magnification level by which a subset of the network activity is subsequently monitored.

28. The computer-usable medium as recited in claim 27, wherein the computer-usable medium comprises a storage device, a processing device or a transmission medium.
